(19) United States
(12) Patent Application Publication
(10) Pub. No.: US 2025/0088450 A1
(43) Pub. Date: Mar. 13, 2025

(54) SYSTEMS AND METHODS FOR MANAGING NODES IN A ROUTE HEALTH INJECTION DEPLOYMENT

(71) Applicant: Citrix Systems, Inc., Fort Lauderdale, FL (US)

(72) Inventors: Jyotheesh Rao Kurma, Bangalore (IN); Saravanan Jayaraman, Bangalore (IN); Pulkit Gupta, Bangalore (IN); Subash Dangol, Bangalore (IN)

(21) Appl. No.: 18/465,237

(22) Filed: Sep. 12, 2023

(51) Int. Cl. H04L 45/03; H04L 45/24

(52) U.S. Cl. CPC H04L 45/03; H04L 45/24

(57) ABSTRACT

Systems and methods for managing nodes in an RHI deployment may include receiving, by a first device intermediary to one or more clients and one or more servers, a signal to switch from a first state to a second state. The systems and methods can include transmitting, by the first device, a message to one or more second devices in an RHI deployment, the message comprising information relating to a plurality of connections of the one or more clients or the one or more servers maintained by the first device. The systems and methods can include switching, by the first device, to the second state responsive to transmitting the message.

### FIELD OF THE DISCLOSURE

The present application generally relates to managing nodes in a route health injection (RHI) deployment. In particular, the present application relates to systems and methods for removing, updating, and adding nodes in an RHI deployment.

### BACKGROUND

Network devices may perform various configuration procedures (e.g., addition, removal, or upgrade) while communicating network traffic. Performing the procedures during communication of the network traffic may disrupt the network traffic, leading to technical disadvantages, such as downtime between packet requests and responses.

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

Some network environments may deploy network nodes (e.g., network devices, devices, etc.) in an route health injection (RHI) deployment. For example, a client may send a request via a route to a virtual internet protocol (VIP) address. The route may include an upstream router in communication with one or more network nodes in the RHI deployment. The one or more network nodes may be in communication with a virtual server (e.g., or a physical server) using the VIP. The router may receive the request, and may route the request to a network node which in turn may send the request to the server. The server may send a response back along the route, through the network node and the router, to the client. The request and response communication may be an example of a communication session, where the communication session may include one or more request and response messages associated with a common task (e.g., a call, a video, a webpage, etc.). In some cases, the router may perform traffic distribution based on an equal cost multi-path (ECMP) technique. In the RHI deployment, the network nodes may be standalone (e.g., unaware of a presence of other network nodes in the same deployment). As such, network configurations for each network node may be independent from the other network nodes.

In some cases, the network nodes in the RHI deployment may perform one or more configuration procedures. The configuration procedures may include addition, removal, and upgrade, among other types of procedures. For example, a network node may be removed from the deployment, upgraded (e.g., firmware, software, or other upgrade), and added back into the deployment, or any single procedure may be performed individually. Performing one or more of the procedures may result in disadvantages related to network performance. For example, removal or addition of a node in the RHI deployment may lead to disruption in network traffic. During removal, some network systems may re-route and reset existing connections managed by the node to another node, disrupting any communication session in effect. During addition, some network systems may perform a route recalculation (e.g., an ECMP recalculation), which may lead to existing connections (e.g., communication session) being assigned to the new node being added, disrupting or dropping existing network traffic. Similarly, upgrading the node may cause a reboot during the upgrade procedure, which may result in traffic disruption and downtime for a communication session between a client and a server.

Systems and methods described herein may be configured to perform addition, removal, and upgrade of a node in deployment, without traffic disruption. For example, a first network node that is part of an RHI deployment (e.g., in communication with one or more servers and a router) may be removed. The first node may be removed (e.g., switch from an online state to an offline state, stop advertising availability to the router, etc.) due to software or hardware issues, for the purpose of maintenance, for upgrades or downgrades, due to technical deficiencies in the networking process (e.g., the upstream router losing the ECMP route pointing to the node), among other use cases. To remove the first node, the first node may sync (e.g., send, communicate, transmit, share, or otherwise provide) information (e.g., minimal connection information) to other nodes in the same RHI deployment with the first node. The information may be associated with existing connections maintained by the first node. The other nodes may register the information (e.g., four tuple, five tuple, etc.) and re-route traffic associated with the existing connections to the first node. Responsive to completion of the sync, the first node may withdraw a route (e.g., connection) between the first node and the router. Due to withdrawal of the route, new connections (e.g., communication sessions) will not reach the first node.

The first node may stay online (e.g., stay alive, stay active) until the communication sessions maintained by the first node are complete. For example, due to the sync, the other nodes may receive network traffic associated with the communication sessions maintained by the first node from the router. The other nodes may re-route the network traffic to the first node via tunneling (e.g., generic routing encapsulation (GRE) tunneling, other tunneling methods) from node IP address to node IP address. As part of the tunneling, the other nodes may forward a complete network packet of the network traffic, including an ethernet header. The first node may receive the network traffic via the tunneling and send the traffic to the clients and/or the servers associated with the network traffic (e.g., without the router). In some cases, for the client-side, the first node may use mac-based forwarding based on information stored in the connections. The systems and methods described herein may apply for one or more simultaneous removals of network nodes by performing the methods on each node as the node goes offline.

In some examples, a first network node that is part of an RHI deployment may be added. The first node may be added (e.g., switch from an offline state to an online state, advertise availability to a router) due to physically adding a new node, for the purpose of maintenance, during upgrades or downgrades, or due to the router calculating to add a new route pointing to the first node based on a route analysis (e.g., ECMP analysis). To add the first node, other nodes in the same RHI deployment with the first node may sync (e.g., send, communicate, transmit, share, or otherwise provide) information (e.g., minimal connection information) to each other (e.g., to other nodes). The information may be associated with existing connections maintained by each of the other nodes. The other nodes may register the information (e.g., client side four tuple, five tuple, etc.) and re-route traffic associated with the existing connections to respective nodes (e.g., the first node, another node, etc.) based on route path analysis (e.g., ECMP). To do so, the other nodes may perform a tunneling technique. The tunneling technique may include the other nodes performing a distributed flow distribution (DFD) type steering through tunneling (e.g., GRE tunneling, other types of tunneling) based on the minimal information (e.g., four tuple, source IP address, destination IP address, source port, destination port). DFD sessions may include node information associated with the connection owner. When a DFD session gets a hit on a target node, the source node performs tunneling to the target node. Responsive to completion of the sync, the first node may add a route (e.g., connection) between the first node and the router. The router may serve the existing connections to the respective nodes. The systems and methods described herein may apply for one or more simultaneous additions of network nodes by performing the methods on each node as the node comes online.

An aspect of this disclosure provides a method. The method can include receiving, by a first device intermediary to one or more clients and one or more servers, a signal to switch from a first state to a second state. The method can include transmitting, by the first device, a message to one or more second devices in a route health injection (RHI) deployment with the first device, the message comprising information relating to a plurality of connections of the one or more clients or the one or more servers maintained by the first device. The method can include switching, by the first device, to the second state responsive to transmitting the message.

In some embodiments, wherein the information comprises, for each connection, a source internet protocol (IP) address, a destination IP address, a source port, a destination port, and a protocol. In some embodiments, the first state comprises an online state and wherein the second state comprises an offline state. In some embodiments, switching to the second state comprises ceasing advertising availability of the first device to a router intermediary to the one or more clients and the first device. In some embodiments, the signal comprises a command indicating the switch, the command comprising one of a first command type or a second command type. In some embodiments, the first command type comprises an inbound node command specifying information relating to one or more inbound connections, and the second command type comprises an outbound command specifying information relating to one or more outbound connections.

In some embodiments, the method can include responsive to transmitting the message, receiving, by the first device, network traffic from the one or more second devices, the network traffic comprising data relating to one or more communication sessions associated with the plurality of connections of the one or more clients or the one or more servers maintained by the first device. The method can include communicating, by the first device, the network traffic between the one or more clients and the one or more servers, wherein switching from the first state to the second state is further responsive to completing the one or more communication sessions.

In some embodiments, the method can include receiving, by the first device, a second signal to switch from the second state back to the first state, the first device receiving the second signal responsive to an update of the first device. The method can include receiving, by the first device, one or more messages from each of the one or more second devices, the one or more messages comprising information relating to connections maintained by a respective second device. The method can include switching, by the first device, from the second state to the first state responsive to receiving the one or more messages. The method can include receiving, by the first device from a router intermediary to the one or more clients and the first device, responsive to switching back to the first state, data of a connection previously maintained by a second device of the one or more second devices. In some embodiments, switching to the first state comprises advertising, by the first device, availability for connections with a router intermediary to the one or more clients and the first device.

Another aspect of this disclosure provides a method. The method can include receiving, by a first device intermediary to one or more clients and one or more servers, a signal to switch from a first state to a second state. The method can include receiving, by the first device, one or more messages from one or more second devices in a route health injection (RHI) deployment with the first device, each message comprising information relating to a plurality of connections of the one or more clients or the one or more servers maintained by a respective second device. The method can include switching, by the first device, to the second state responsive to transmitting the message.

In some embodiments, the first state comprises an offline state and wherein the second state comprises an online state. In some embodiments, the first device receives the signal responsive to at least one of an initial deployment of the first device or an update to the first device. In some embodiments, the method can include receiving, by the first device from a router intermediary to the one or more clients and the first device, responsive to switching to the second state, data of a connection previously maintained by a second device of the one or more second devices. In some embodiments, the method can include advertising, by the first device, availability for connections with the router, wherein the data of the connection is received responsive to advertising the availability. In some embodiments, the information comprises, for each connection, a source internet protocol (IP) address, a destination IP address, a source port, a destination port, and a protocol.

Another aspect of this disclosure provides a system. The system can include one or more processors of a first device intermediary to one or more clients and one or more servers. The processors can be configured to receive a signal to switch from a first state to a second state. The processors can be configured to transmit a message to one or more second devices in a route health injection (RHI) deployment with the first device, the message comprising information relating to a plurality of connections of the one or more clients or the one or more servers maintained by the first device. The processors can be configured to switch to the second state responsive to transmitting the message.

In some embodiments, the information comprises, for each connection, a source internet protocol (IP) address, a destination IP address, a source port, a destination port, and a protocol. In some embodiments, the first state comprises an online state and wherein the second state comprises an offline state. In some embodiments, the signal comprises a command indicating the switch, the command comprising one of a first command type or a second command type, wherein the first command type comprises an inbound node command specifying information relating to one or more inbound connections, and the second command type comprises an outbound command specifying information relating to one or more outbound connections. In some embodiments, the processors can be configured to receive, responsive to transmitting the message, network traffic from the one or more second devices, the network traffic comprising data relating to one or more communication sessions associated with the plurality of connections of the one or more clients or the one or more servers maintained by the first device. The processors can be configured to communicate the network traffic between the one or more clients and the one or more servers, wherein switching from the first state to the second state is further responsive to termination of the one or more communication sessions.

Another aspect of this disclosure provides a method. The method can include establishing, by a router intermediary to one or more clients and a first device, one or more first connections between the router and the first device. The method can include determining, by the router, an absence of an advertisement from the first device, responsive to the first device switching from a first state to a second state responsive to communicating information relating to the one or more first connections maintained by the first device to one or more second devices in a route health injection (RHI) deployment with the first device. The method can include routing, by the router, network traffic associated with the one or more first connections of the first device to the one or more second devices.

In some embodiments, the method can include receiving, by the router, an advertisement from the first device responsive to the first device switching from the second state to the first state. The method can include establishing, by the router, one or more second connections between the router and the first device based on the advertisement. The method can include routing, by the router, network traffic associated with the one or more second devices to the first device. The method can include routing the network traffic to the one or more second devices to minimize disruption of the network traffic when the first device switches to the second state.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 and FIG. 6 are diagrams of a network environment including nodes in an RHI deployment, in accordance with an illustrative embodiment;

FIG. 7 is a process flow diagram for managing packets by a node in an RHI deployment, in accordance with an illustrative embodiment;

FIG. 8 is a flow diagram of a method for switching a node from a first state (e.g., an online state) to a second state (e.g., an offline state), in accordance with an illustrative embodiment;

FIG. 9 is flow diagram of a method for switching a node from a first state (e.g., an offline state) to a second state (e.g., an online state), in accordance with an illustrative embodiment;

FIG. 10 is a flow diagram of a method of routing traffic to nodes in an RHI deployment, in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for virtualizing an application delivery controller;
Section D describes embodiments of systems and methods for providing a clustered appliance architecture environment;
Section E describes systems and methods for managing nodes in an RHI deployment.
Section F describes embodiments of systems and methods for managing nodes in an RHI deployment.

### A. Network and Computing Environment

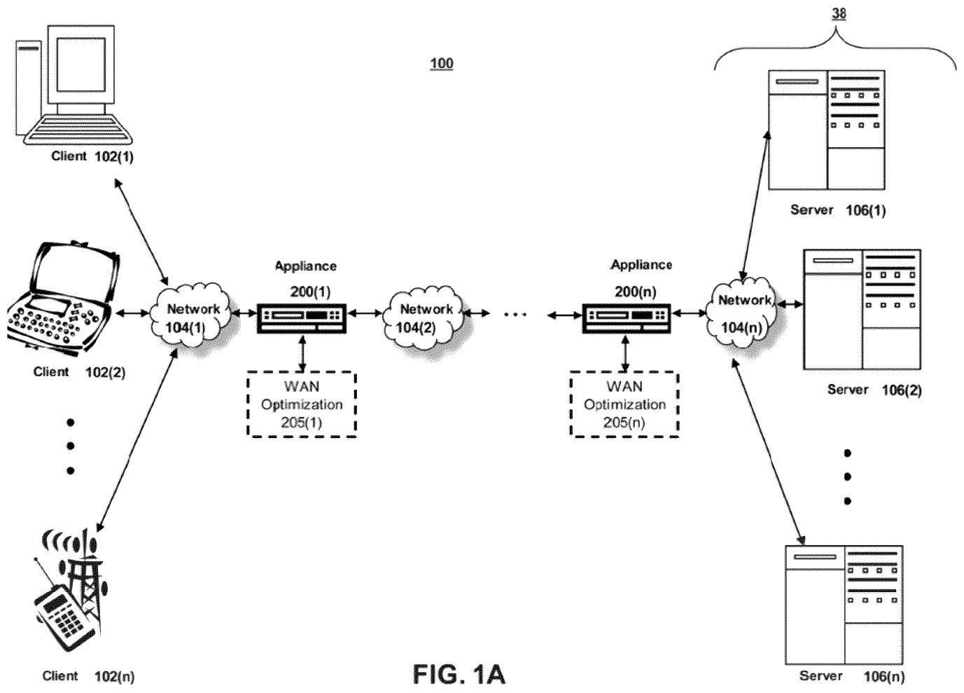

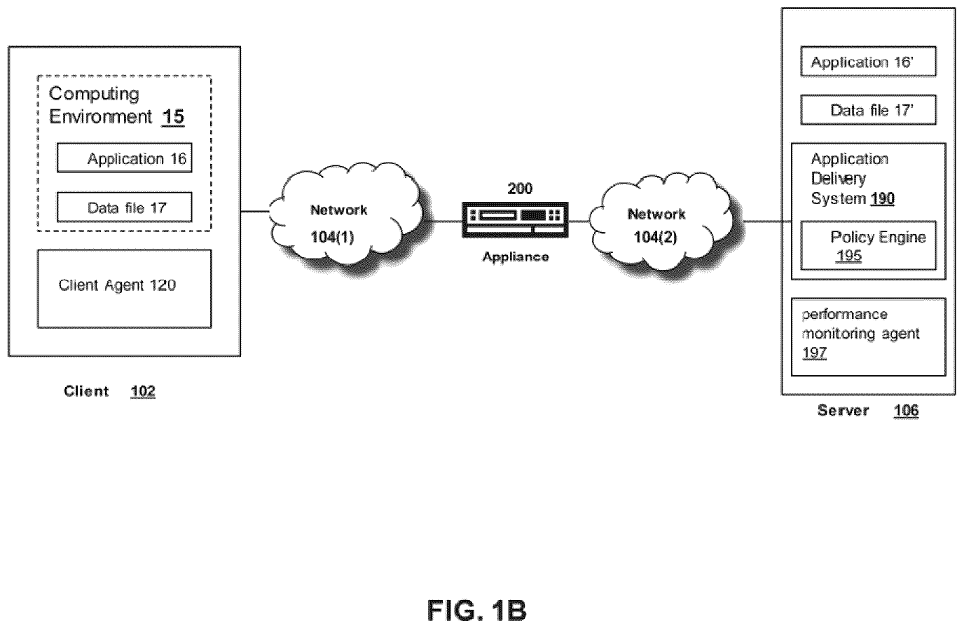

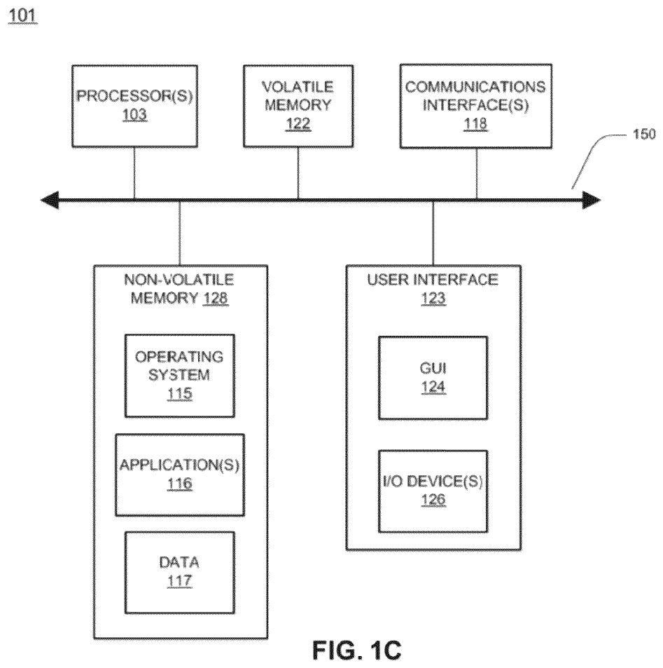

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device (e.g., a network node) such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 102 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

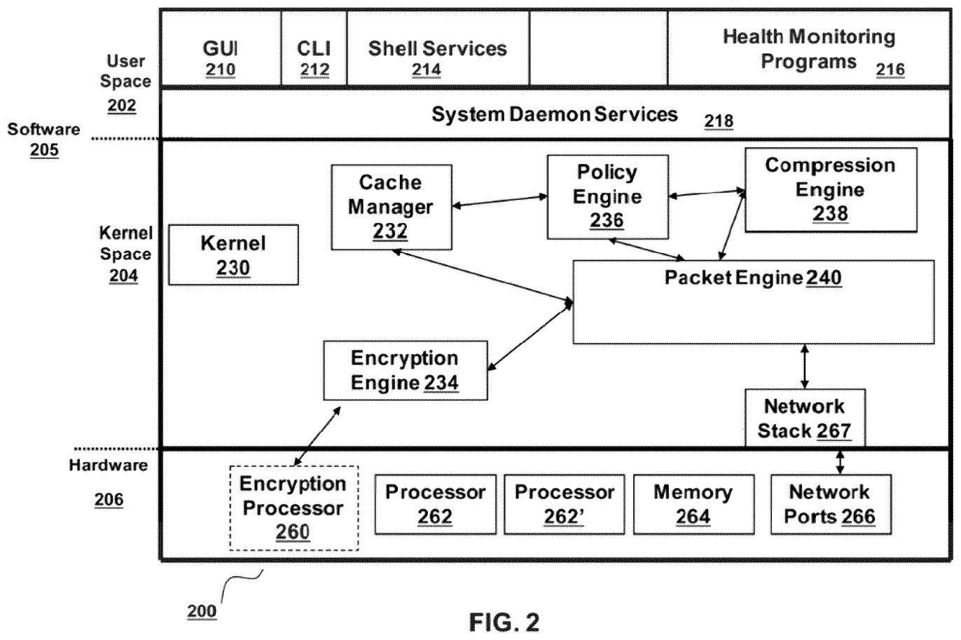

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of appliance 200. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

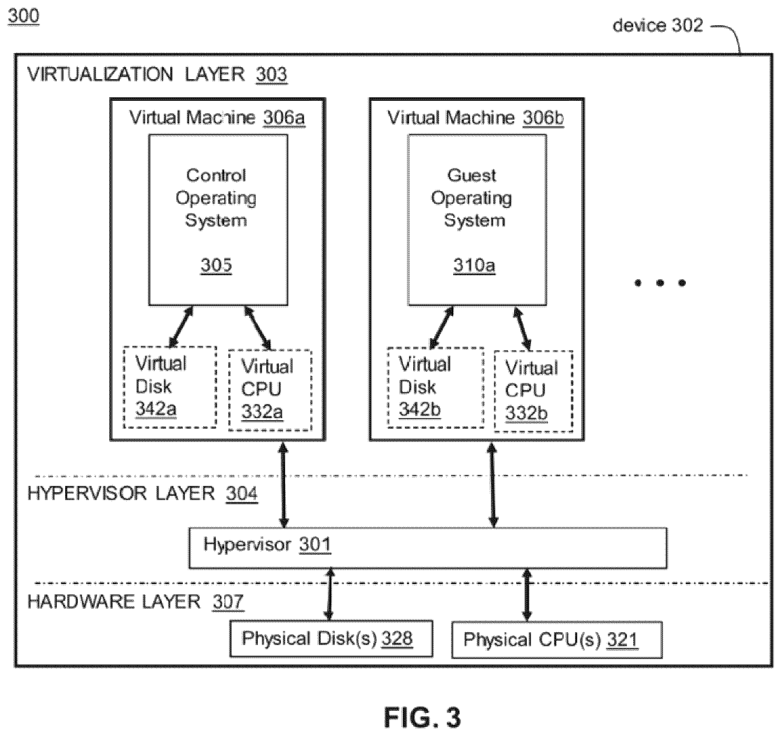

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, FL. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

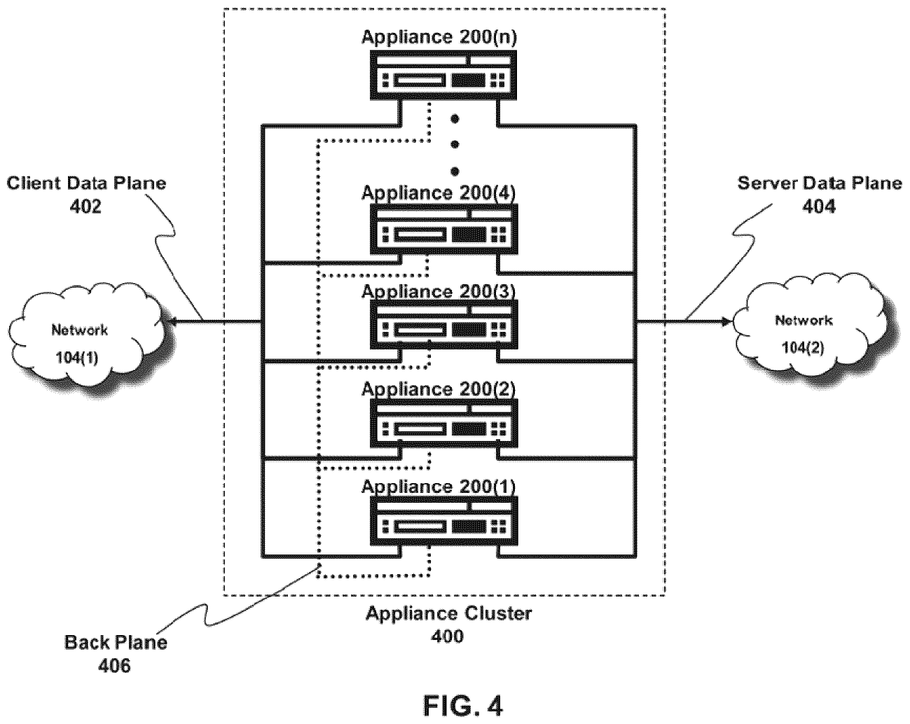

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Managing Nodes in an RHI Deployment

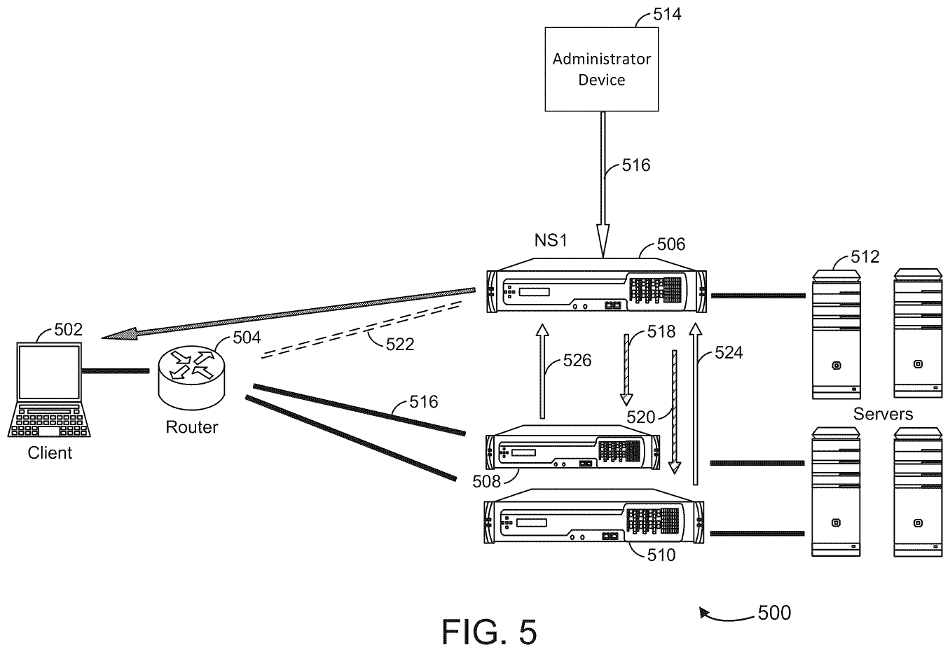

FIG. 5 is a diagram of a network environment 500 for managing nodes in an RHI deployment, in accordance with an illustrative embodiment. The network environment 500 can include one or more clients 502, one or more routers 504, one or more network nodes 506-510 (e.g., network devices, devices), one or more servers 512, and an administrator device 514. In some cases, the client 502, the router 504, the network nodes 506-510, and the servers 512 may be respective examples of the client 102, the network 104, the appliance 200, and the server 106, as described herein with reference to FIGS. 1-4. The administrator device 514 may be any computing device facilitating an administrative user to interact with or otherwise manage the network environment 500. The administrator device 514 may be any computing device including a processor and non-transitory machine-readable storage medium. The client 502 may be in communication with the router 504 (e.g., via a local area network, a wireless local area network, a wide area network, etc.). The router 504 may be in communication with the network nodes 506-510. The network nodes 506-510 may be in communication with the servers 512 and the administrator device 514. In some implementations, the network nodes 506-510 may be in communication with each other and/or the client 502.

In some examples, the network node 506 may be removed from the network environment 500. For example, the network node 506 may be removed due to software or hardware issues, for the purpose of maintenance, for upgrades or downgrades, or due to technical deficiencies in the network process (e.g., the router 504 losing the ECMP route pointing to the node), among other reasons. Removal of the network node 506 may include switching the network node from an online state to an offline state, stopping advertisement of the network node 506 to the router 504, physically removing the network node 506 from one or more connections (e.g., wires, cables, etc.), among other examples.

In some cases, removal of the network node 506 may result in traffic disruption. For example, the network node 506 may be facilitating communications (e.g., responses and requests, network traffic, data packets, communication sessions) from the client 502, via the router 504, to the servers 512 and from the servers 512 to the client 502, via the router 504. A communication session may include one or more request and response messages associated with a service, where a service may include the supplying or providing of information (e.g., voice, video, cellular, digital, etc., data) over a network. When the network node 506 is removed, the communication sessions maintained by the network node 506, via a connection 522 between the network node 506 and the router 504, may experience one or more disruptions (e.g., a lag or a stall in service, a dropped service, missing portions of the service, etc.). For instance, the router 504 may reroute or restart the communication sessions maintained by the network node 506 to the network nodes 508 and 510, via connections 516. However, a duration of time before the router 504 reroutes or restarts the communication sessions may cause delays or dropped service.

To overcome the deficiencies, the network node 506 may receive a signal. For example, the network node 506 may receive a signal to switch from a first state to a second state. The network node 506 may receive the signal from an administrator device 514. The administrator device 514 may indicate to the network node 506 to switch from an on state to an off state (e.g., with respect to the network environment 500).

The network node 506 may transmit a message. The network node 506 may transmit a message 518 to the network node 508 and a message 520 to the network node 510. In some cases, the messages 518 and 520 may include one or more parameters for successfully identifying and connecting the network node 506 with the network nodes 508 and 510. For example, the messages 518 and 520 may include an identifier (ID) associated with the respective destination network nodes 508 and 510, a password, an indication of security, and an ID indicating a type of interface to use for node-to-node communication, among other parameters. In some cases, the message may include a command. The command may be to start migration of connections maintained by the network node 506 to the network nodes 508 and 510. To do so, the messages 518 and 520 may include a “from nodes IP” parameter, password details, whether the connection between the nodes is secure, and a virtual local area network (VLAN) ID to indicate a VLAN interface for the node-to-node communication, among other information which may be included in the messages 518, 520. The from nodes IP parameter may be the IP address of the network node 506.

The network nodes 508 and 510 may transmit messages. The network nodes 508 and 510 may transmit messages 526 and 524, respectively, to the network node 506. The messages 526 and 524 may be similar to the messages 518 and 520. For instance, the messages 526 and 524 may include a “to nodes IP” parameter, password details, whether the connection between the nodes is secure, and a VLAN ID to indicate a VLAN interface for the node-to-node communication, among other information. The to nodes IP parameter included in the messages 526 and 524 may be the IP address of the respective network nodes 508 and 510 (e.g., IP address of the network node 508 for message 526 and IP address of the network node 510 for message 526). In some cases, the network nodes 506, 508, and 510 may determine the IP address of the other nodes based on a from/to nodes list. The from/to nodes list may be preconfigured at the respective network nodes 506, 508, and 510 (e.g., during a deployment phase). The from/to nodes list may be indicated to the network nodes 506, 508, and 510 by the administrator device 514, the router 504, or another entity.

The network node 506 may establish respective connections with the network nodes 508 and 510. The network node 506 may establish the connections based on the security and password details communicated in the messages 518, 520, 524, and 526. The connections may be node-to-node connections between the network node 506 and the network nodes 508 and 510. In some cases, the connections may be remote procedure call (RPC) connections. For example, the connections may use a node-to-node interface (e.g., VLAN) to communicate messages (e.g., data packets) between the network nodes 506, 508, and 510.

Responsive to establishing the respective connections, the network node 506 may transfer, transmit, communicate, send, or otherwise provide information relating to communication sessions maintained by the network node 506 (e.g., via the connection 522) to the network nodes 508 and 510. The information may include IDs, headers, and other data packet information associated with the communication sessions maintained by the network node 506. For example, the information may include a tuple (e.g., a four tuple, a five tuple), where the tuple may include any combination of a source IP address, a destination IP address, a source port, a destination port, a protocol, and other relevant information. The information may be or include minimal information for receiving and processing data packets from the router 504 associated with the communication sessions. The information may include layer 4 (L4) sessions. The network node 506 may migrate the information to the network nodes 508 and 510 via the RPC connection. In some implementations, a data structure size of the information may be minimal, such that a memory capacity of the network nodes 508 and 510 may not be overloaded. In some examples, information associated with any new incoming connections between the router 504 and the network node 506 established during the migrating of the information, is also migrated.

Responsive to completing the migration of the information of the communication sessions maintained by the network node 506 to the network nodes 508 and 510, the network node 506 may withdraw the connection 522 (e.g., a route between the router 504 and the network node 506). For example, the network node 506 may cease, stop, halt, pause, or otherwise forego advertising availability of the network node 506 to the router 504. The network node 506 may automatically withdraw the connection 522 responsive to complete traversal (e.g., migration, transfer) of the information.

The network nodes 508 and 510 may receive network traffic from the router 504. The network nodes 508 and 510 may receive network traffic associated with the communication sessions maintained by the network node 506 based on the migrated information. The network nodes 508 and 510 may relay (e.g., send, transfer, transmit) the network traffic to the network node 506. To do so, the network nodes 508 and 510 may establish tunneling connections (e.g., GRE tunneling, IPsec, other types of tunneling) between the network nodes 508 and 510 and the network node 506. The network nodes 508 and 510 may transmit (e.g., reroute) the network traffic to the network node 506. To do so, the network nodes 508 and 510 may forward a complete network packet including an ethernet header from network node IP to network node IP (e.g., from source IP to destination IP). In some cases, the network nodes 508 and 510 may transmit the network traffic received from the router 504 associated with the communication sessions until completion of the communication sessions (e.g., the client 502 ends the task, the communication session is terminated, all requests associated with the communication session are completed).

The network node 506 may receive the network traffic from the network nodes 508 and 510. For example, the network node 506 may receive the network traffic associated with the communication sessions maintained by the network node 506 from the network nodes 508 and 510 via the tunneling connection. Responsive to receiving the network traffic, the network node 506 may communicate the network traffic to a target of the network traffic (e.g., the servers 512, the client 502) directly (e.g., rather than via the router 504) based on stored information (e.g., layer 2 (L2) information, stored from an establishing procedure performed upon initiation of the communication session). To do so, the network node 506 may use mac-based forwarding based on the stored information. In this way, the network node 506 may complete each communication session maintained by the network node 506 without interruption (e.g., disruption, stall, reset, drop). Because the network node 506 withdrew the connection 522, the router 504 may not establish new connections with the network node 506. Upon completion of the existing connections (e.g., communication sessions) maintained by the network node 506, the network node 506 may switch from the on state to the off state (e.g., be removed from the network environment 500).

While the example of FIG. 5 is illustrated with removal of a single network node in an RHI deployment with two other network nodes, it is understood that any number of network nodes may be removed in a deployment with any number of other network nodes using the techniques described herein. The techniques as described herein may provide advantages over some systems. For example, the techniques may preclude the need for synchronized key or consensus protocol/operational views. During a time of removal (e.g., only during the time of removal), a view of each node is fed to each node in the deployment (e.g., each node may be unaware of the other nodes except for during a removal process), and connection information of the removed node (e.g., the network node 506) may be shared with the other nodes (e.g., network nodes 508 and 510) via a connection sync.

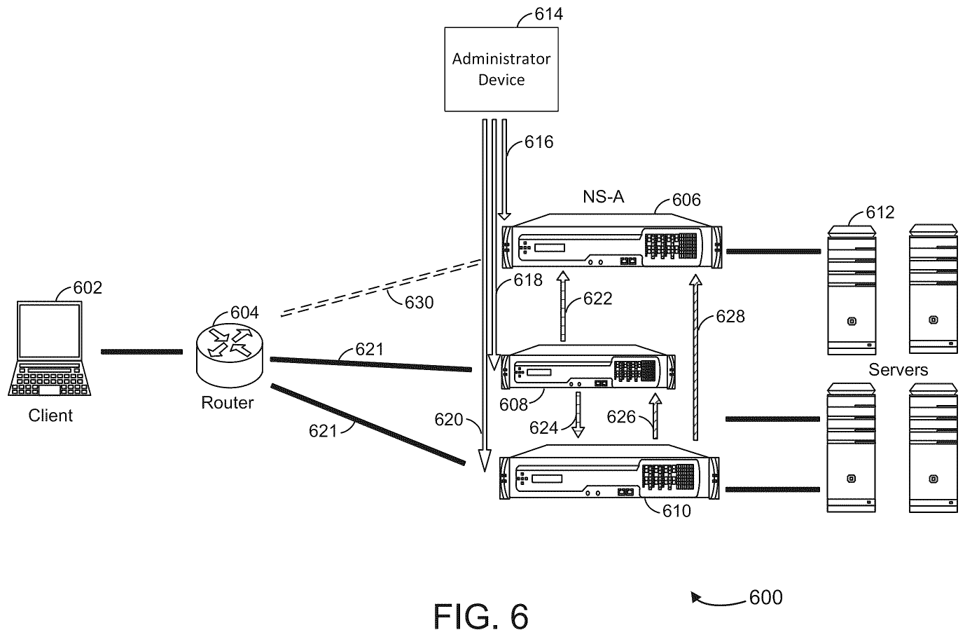

FIG. 6 is a diagram of a network environment 600 for managing nodes in an RHI deployment, in accordance with an illustrative embodiment. The network environment 600 can include, interface, or otherwise communicate with one or more clients 602, one or more routers 604, one or more network nodes 606-610 (e.g., network devices, devices), one or more servers 612, and an administrator device 614. In some cases, the client 602, the router 604, the network nodes 606-610, and the servers 612 may be respective examples of the client 102, the network 104, the appliance 200, and the server 106, as described herein with reference to FIGS. 1-4. The client 602 may be in communication with the router 604. The router 604 may be in communication with the network nodes 606-610. The network nodes 606-610 may be in communication with the servers 612 and the administrator device 614. In some implementations, the network nodes 606-610 may be in communication with each other and/or the client 602.

In some examples, a network node 606 may be added to the network environment 600. For example, the network node 606 may be a physically added new node to the network environment 600, e.g., for the purpose of maintenance, during upgrades or downgrades, due to the router calculating to add a new route pointing to the first node based on a route analysis (e.g., ECMP analysis), and so forth. Addition of the network node 606 may include switching the network node from an offline state to an online state, initiating advertisement of the network node 606 to the router 604, physically adding the network node 606 via one or more connections (e.g., wires, cables, etc.), among other examples.

In some cases, addition of the network node 606 may result in traffic disruption. For example, the network nodes 608 and 610 may be facilitating communications (e.g., responses and requests, network traffic, data packets, communication sessions) from various client(s) 602, via the router 604, to the servers 612 and from the servers 612 to the various client(s) 602, via the router 604. A communication session may include one or more request and response messages associated with a service, where a service may include the supplying or providing of information (e.g., voice, video, cellular, digital, etc., data) over a network. When the network node 606 is added, the communication sessions maintained by the network node 606, via a connection 622 between the network node 606 and the router 604, may experience one or more disruptions (e.g., a lag or a stall in service, a dropped service, missing portions of the service, etc.). For instance, the router 604 may reroute or restart the communication sessions maintained by the network nodes 608 and 610 to the network node 606, via a connection 630 (e.g., due to the new route pointing to the network node 606 and based on route analysis). However, a duration of time before the router 604 reroutes or restarts the communication sessions may cause delays or dropped service.

To overcome the deficiencies, the network nodes 608 and 610 may receive a signal. For example, the network nodes 606, 608, and 610 may receive respective signals 616, 618, and 620 to switch the network node 606 from a first state to a second state. The network nodes 606, 608, and 610 may receive the signal from an administrator device 614. The administrator device 614 may indicate to the network node 606 to switch from an off state to an on state (e.g., with respect to the network environment 600).

The network nodes 608 and 610 may transmit a message to each network node in the network environment 600. The network node 608 may transmit a message 622 to the network node 606 and a message 624 to the network node 610. The network node 610 may similarly transmit a message 626 to the network node 608 and a message 628 to the network node 606. In some cases, the messages 622, 624, 626, and 628 may include one or more parameters for successfully identifying and connecting the network nodes 608 and 610 with the network node 606. For example, the messages 622, 624, 626, and 628 may include an ID associated with the respective target network nodes 608 and 610, a password, an indication of security, and an ID indicating a type of interface to use for node-to-node communication, among other parameters. In some cases, the message may include a command. The command may be to start migration of connections (e.g., information for each connection) maintained by the network nodes 608 and 610 to the network nodes 608, 610, and 606. To do so, the messages 622, 624, 626, and 628 may include a “to nodes IP” parameter, a “from nodes IP” parameter, password details, whether the connection between the nodes is secure, and a virtual local area network (VLAN) ID to indicate a VLAN interface for the node-to-node communication. For the messages 622 and 624, the to nodes IP parameter may be the IP address of the network nodes 610 and 606 and the from nodes IP parameter may be the IP address of the network node 608. For the messages 626 and 628, the to nodes IP parameter may be the IP address of the network nodes 608 and 606 and the from nodes IP parameter may be the IP address of the network node 610. The network node 606 may execute the command received from the messages 622 and 628 to start migration of connections maintained by the network nodes 608 and 610. In some cases, the network nodes 608 and 610 may determine the IP address of the other nodes based on a from/to nodes list. The from/to nodes list may be preconfigured at the respective network nodes 608 and 610 (e.g., during a deployment phase). The from/to nodes list may be indicated to the network nodes 608 and 610 by the administrator device 614, the router 604, or another entity.

The network nodes 608 and 610 may establish respective connections with the network nodes 606, 608, and 610. The network nodes 608 and 610 may establish the connections based on the security and password details communicated in the messages 622, 624, 626, and 628. The connections may be node-to-node connections between the each of the network nodes 606, 608, and 610 and another one of the network nodes 606, 608, and 610. In some cases, the connections may be remote procedure call (RPC) connections. For example, the connections may use a node-to-node interface (e.g., VLAN) to communicate messages (e.g., data packets) between the network nodes 606, 608, and 610.

Responsive to establishing the respective connections, the network nodes 608 and 610 may transfer (e.g., transmit, send) information relating to communication sessions maintained by the network nodes 608 and 610 (e.g., via connections 621) to the network nodes 606, 608, and 610. The information may include IDs, headers, and other data packet information associated with the communication sessions maintained by the network nodes 608 and 610. For example, the information may include a tuple (e.g., a four tuple, a five tuple), where the tuple may include any combination of a source IP address, a destination IP address, a source port, a destination port, a protocol, and other relevant information. The information may be or include minimal information for receiving and processing data packets from the router 604 associated with the communication sessions. The information may include layer 4 (L4) sessions. The network nodes 608 and 610 may migrate the information to the network nodes 606, 608, and 610 via the RPC connection. In some implementations, a data structure size of the information may be minimal, such that a memory capacity of the network nodes 606, 608, and 610 may not be overloaded. In some examples, information associated with any new incoming connections between the router 604 and the network nodes 608 and 610 established during the migrating of the information, is also migrated.

Responsive to completing the migration of the information of the communication sessions maintained by the network nodes 608 and 610 to the network nodes 606, 608, and 610, the network node 606 may establish the connection 630 (e.g., a route between the router 604 and the network node 606). For example, the network node 606 may begin (e.g., initiate, renew) advertising availability of the network node 606 to the router 604. The network node 606 may automatically establish the connection 630 responsive to complete traversal (e.g., migration, transfer) of the information.

Responsive to the establishment of the connection 630, the router 604 may perform a routing analysis and alter paths associated with various communication sessions maintained by the network nodes 608 and 610. For instance, the router 604 may perform an ECMP analysis and determine to route one or more communication sessions maintained by the network nodes 608 and 610 to the network node 606.

If the network nodes 606, 608, and 610 receive peer node intended traffic from the router 604 due to the addition process, the network nodes may relay (e.g., transfer, send, transmit) the traffic to the intended network node. For example, the network nodes 606, 608, and 610 may receive network traffic associated with the communication sessions previously maintained by the network nodes 608 and 610. The network nodes 606, 608, and 610 may relay the network traffic to the target node (e.g., the network node currently maintaining the connection associated with the network traffic). To do so, the network nodes 606, 608, and 610 may establish tunneling connections (e.g., GRE tunneling, IPsec, or other types of tunneling) between the network nodes 606, 608, and 610. The network nodes 606, 608, and 610 may transmit (e.g., reroute) the network traffic to the target not. To do so, the network nodes 608 and 610 may use DFD sessions to perform DFD type steering via GRE tunneling, where DFD session may have the connection owner node information. When a DFD session gets a hit on a node, the source network node establishes a GRE tunnel to the target node. In some cases, the network nodes 606, 608, and 610 may transmit the network traffic received from the router 604 associated with the communication sessions until completion of the communication sessions (e.g., the client 602 ends the task, the communication session is terminated, all requests associated with the communication session are completed).

While the example of FIG. 6 is illustrated with addition of a single network node in an RHI deployment with two other network nodes, it is understood that any number of network nodes may be added in a deployment with any number of other network nodes using the techniques described herein. The techniques as described herein may provide advantages over some systems. For example, the techniques may preclude the need for consistent hashing and protocol/operational views. During a time of addition (e.g., only during the time of addition), a view of each node is fed to each node in the deployment (e.g., each node may be unaware of the other nodes except for during an addition process), and connection information of the added node (e.g., the network node 606) may be shared with the other nodes (e.g., network nodes 608 and 610) via a connection sync, which may result in no connection lose due to rehashing of routes.

In some implementations, the network node 606 may be added to the network environment 600 based on an update. For example, the network node 606 may be included in the network environment 600. The network node 606 may be scheduled to perform an update (e.g., a software update, a firmware update, another type of update). To perform the update, the administrator device 614 may signal to the network node 606 to switch from an on state to an off state, as described herein with reference to FIG. 5 (e.g., be removed from the network environment 600). Responsive to removing the network node 606, the network node 606 may perform the update. Responsive to performing the update, the network node 606 may be added back into the network environment 600, as described herein with reference to FIG. 6.

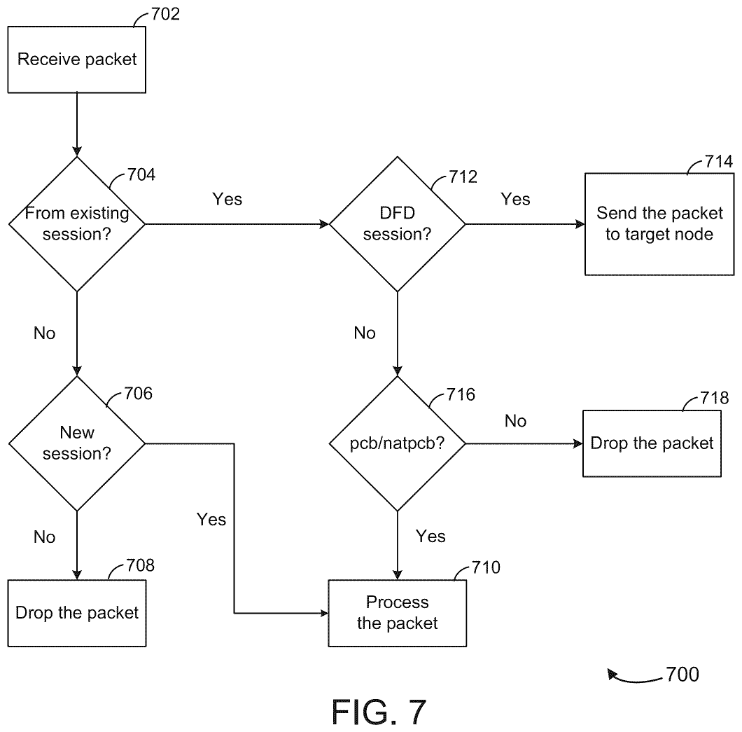

FIG. 7 is an illustration of a process flow diagram 700 for managing packets by a node in an RHI deployment, in accordance with an illustrative embodiment. The process flow diagram 700 can be performed by one or more system, component, hardware, or element depicted in FIGS. 1-6, including, for example, one or more network nodes (e.g., an appliance), a data processing system, or service of a cloud service provider system. In some cases, the process flow diagram 700 may be performed by a network node other than a network node being added or removed in the same RHI deployment. While the steps of the process flow diagram 700 are described according to an order, any subset or all of the steps may be performed in any order, simultaneously, or omitted.

At operation 702, the network node can receive a packet. The network node may receive the packet from a router, another network node, the network node being added or removed, a server, etc. The packet may be a network packet, a data packet, a message, a signal including the packet, a request from a client, a response from a server, or any other type of message associated with a communication session. At operation 704, the network node can determine whether the packet is associated with an existing session. For example, the network node may determine an ID associated with the packet, a header value of the packet, or some other type of data indicative of the packet (e.g., an ID or packet number associated with a communication session maintained by the network node). If the network node determines the packet is not from an existing session, the network node may continue to operation 706, otherwise to operation 712.

At operation 706, the network node can determine whether the packet is associated with a new session. For example, the network node may determine if the packet is a sync packet (e.g., TCP SYN, SYN), which may indicate the packet is from a new session. In some cases, the network node may determine the packet is a stray packet (e.g., a packet not intended for the network node, a packet not associated with a communication session of the RHI deployment, etc.) and, at operation 708, the network node may drop the packet (e.g., delete, discard, erase, ignore). If the network node determines the packet is associated with the new session, the network node may continue to operation 710. At operation 710, the network node can process the packet (e.g., establish a connection or session and transmit the packet to a target device, such as a router, a server, a client, etc.).

At operation 712, the network node can determine whether the packet is from a DFD session. For example, the network node may determine whether the packet is associated with information relating to one or more communication sessions maintained by another network node. If the network node determines the packet is associated with the DFD session, at operation 714, the network node can send the packet to a target node. For example, the network node can send the packet via a type (e.g., GRE, IPsec) of tunnel (e.g., a channel, a wireless connection) between the network node and the target node.

At operation 716, the network node can determine whether the packet is associated with a protocol control block (PCB) or network address translation PCB (NATPCB). If the network node determines the packet is not associated with the PCB/NATPCB, at operation 718, the network node can drop the packet. If the network node determines the packet is associated with the PCB/NATPCB, the network node may continue to operation 710 and process the packet.

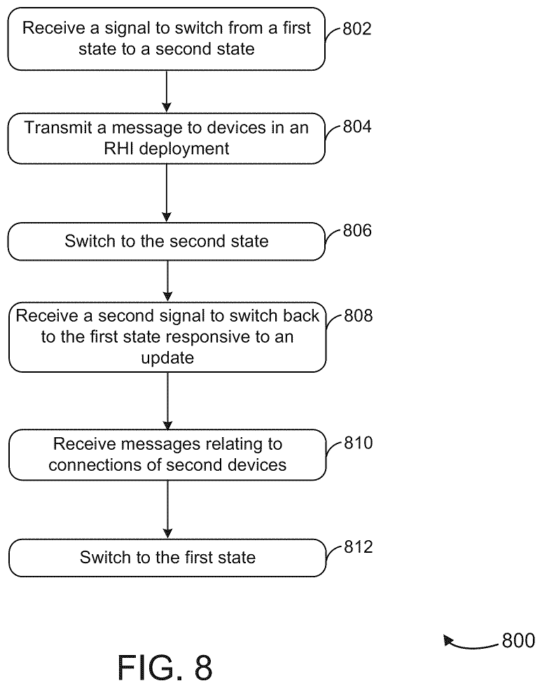

FIG. 8 is a flow diagram of a method 800 of switching a node from a first state (e.g., an online state) to a second state (e.g., an offline state), in accordance with an illustrative embodiment. The method 800 can be performed by one or more system, component, hardware, or elements described above with references to FIGS. 1-7, including, for example, a network node, an appliance, a data processing system, or service of a cloud service provider system. While the steps of the method 800 are described according to an order, any subset or all of the steps may be performed in any order, simultaneously, or omitted. In brief summary, the method 800 includes operation 802, at which a first device can receive a signal to switch from a first state to a second state. At operation 804, the first device can transmit a message to devices in an RHI deployment with the first device. At operation 806, the first device can switch to the second state. At operation 808, the first device can receive a second signal to switch back to the first state responsive to an update. At operation 810, the first device can receive messages relating to connections of second devices. At operation 812, the first device can switch to the first state.

At operation 802, a first device can receive a signal to switch from a first state to a second state. The first device may be intermediary to one or more clients and one or more servers. The first device may receive the signal from an administrator device, a router, a server, or another network entity. The first state may be an online state and the second state may be an offline state. Switching to the second state may include the first device ceasing to advertise availability of the first device to a router intermediary to the one or more clients and the first device. The signal may include a command indicating the switch, where the command may include one of a first command type or a second command type. The first command type may include an inbound node command specifying information relating to one or more inbound connections, and the second command type may include an outbound command specifying information relating to one or more outbound connections.

At operation 804, the first device can transmit a message to one or more second devices in an RHI deployment with the first device. The message may include information relating to multiple connections of the one or more clients or the one or more servers maintained by the first device. At operation 806, the first device can switch to the second state. The first device may switch to the second state responsive to transmitting the message. In some cases, the first device may cease to advertise to the router responsive to transmitting the message. The first device may switch from an on state to an off state responsive to completion of the multiple connections maintained by the first device. The information may include, for each connection, a source IP address, a destination IP address, a source port, a destination port, and a protocol.

Responsive to transmitting the message, the first device can receive network traffic from the one or more second devices. The network traffic may include data relating to one or more communication sessions associated with the multiple connections of the one or more clients or the one or more servers maintained by the first device. The first device can communicate the network traffic between the one or more clients and the one or more servers. The first device switching from the first state to the second state may be further responsive to completing the one or more communication sessions.

At operation 808, the first device can receive a second signal to switch from the second state back to the first state responsive to an update of the first device. The first device may receive the second signal responsive to an update of the first device. At operation 810, the first device can receive one or more messages from each of the one or more second devices. The one or more messages may include information relating to connections maintained by a respective second device. At operation 812, the first device can switch from the second state to the first state. The first device can switch from the second state to the first state responsive to receiving the one or more messages. The first device switching to the first state may include the first device advertising availability for connections with a router intermediary to the one or more clients and the first device. The first device can receive, from a router intermediary to the one or more clients and the first device, and responsive to switching back to the first state, data of a connection previously maintained by a second device of the one or more second devices.

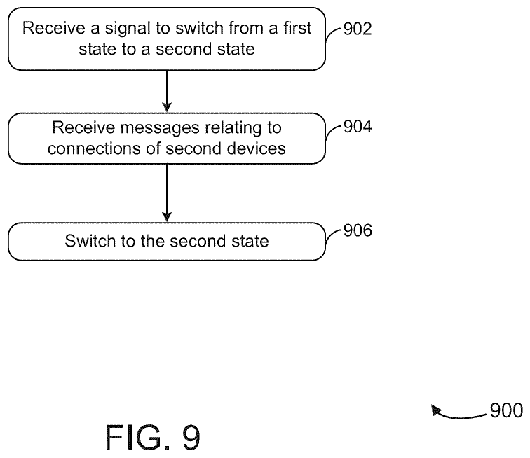

FIG. 9 is flow diagram of a method 900 of switching a node from a first state (e.g., an offline state) to a second state (e.g., an online state), in accordance with an illustrative embodiment. The method 900 can be performed by one or more system, component, element, or hardware described above with reference to FIGS. 1-7, including, for example, a network node, an appliance, a data processing system, or service of a cloud service provider system. While the steps of the method 900 are described according to an order, any subset or all of the steps may be performed in any order, simultaneously, or omitted. In brief summary, the method 900 includes operation 902, at which a first device can receive a signal to switch from a first state to a second state. At operation 904, the first device can receive messages relating to connections of second devices. At operation 906, the first device can switch to the second state.

At operation 902, a first device can receive a signal to switch from a first state to a second state. The first device may be intermediary to one or more clients and one or more servers. The first device may receive the signal from an administrator device, a router, a server, or another network entity. The first device may receive the signal responsive to at least one of an initial deployment of the first device or an update to the first device. The first state may be an offline state and the second state may be an online state. Switching to the second state may include the first device beginning to advertise availability of the first device to a router intermediary to the one or more clients and the first device. The signal may include a command indicating the switch, where the command may include one of a first command type or a second command type. The first command type may include an inbound node command specifying information relating to one or more inbound connections, and the second command type may include an outbound command specifying information relating to one or more outbound connections.

At operation 904, the first device can receive one or more messages from one or more second devices in an RHI deployment with the first device. Each message may include information relating to multiple connections of the one or more clients or the one or more servers maintained by a respective second device. The information may include, for each connection, a source IP address, a destination IP address, a source port, a destination port, or a protocol.

At operation 906, the first device can switch to the second state. The first device can switch to the second state responsive to transmitting the message. The first device may switch to the second state by advertising availability for connections with the router. The first device may receive, from a router intermediary to the one or more clients and the first device, data. The first device may receive the data responsive to switching to the second state. The data may be data of a connection previously maintained by a second device of the one or more second devices. The first device may receive the data of the connection responsive to advertising the availability.

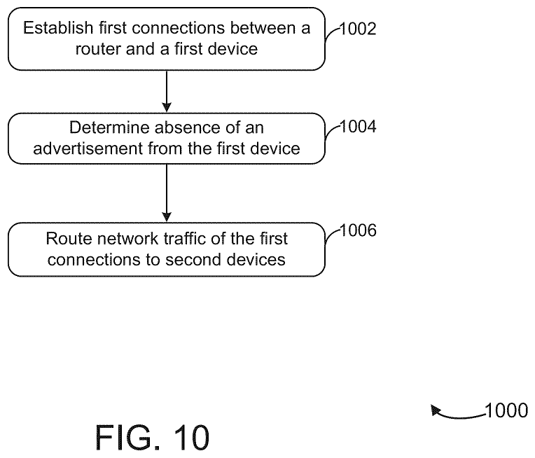

FIG. 10 is flow diagram of a method 1000 of routing traffic to nodes in an RHI deployment, according to an illustrative embodiment. The method 1000 can be performed by one or more system, component, or hardware described above with reference to FIGS. 1-7, including, for example, a router, a data processing system, or service of a cloud service provider system. While the steps of the method 1000 are described according to an order, any subset or all of the steps may be performed in any order, simultaneously, or omitted. In brief summary, the method 1000 includes operation 1002, at which a router can establish first connections between the router and a first device. At operation 1004, the router can determine an absence of an advertisement from the first device. At operation 1006, the router can route network traffic of the first connections to one or more second devices.

At operation 1002, a router can establish one or more first connections between the router and a first device. The router may be intermediary to one or more clients and a first device. The router may establish the one or more first connections based on an advertisement of the first device. The router may perform a route analysis based on establishing the one or more first connections. The router may assign communication sessions to the first device via the one or more first connections based on the route analysis.

At operation 1004, the router can determine an absence of an advertisement from the first device. The router can determine the absence responsive to the first device switching from a first state to a second state responsive to communicating information relating to the one or more first connections maintained by the first device to one or more second devices in an RHI deployment with the first device (e.g., as described above with reference to FIG. 8). At operation 1006, the router can route network traffic associated with the one or more first connections of the first device to one or more second devices.

In some implementations, the router can receive an advertisement from the first device responsive to the first device switching from the second state to the first state. The router may establish one or more second connections between the router and the first device based on the advertisement. The router may route, network traffic associated with the one or more second devices to the first device. The router may route the network traffic to the one or more second devices to minimize disruption of the network traffic when the first device switches to the second state.

### F. Example Embodiments for Managing Nodes in an RHI Deployment

The following examples pertain to further example embodiments, from which permutations and configurations will be apparent.

Example 1 includes a method. The method includes receiving, by a first device intermediary to one or more clients and one or more servers, a signal to switch from a first state to a second state. The method includes transmitting, by the first device, a message to one or more second devices in a route health injection (RHI) deployment with the first device, the message comprising information relating to a plurality of connections of the one or more clients or the one or more servers maintained by the first device. The method includes switching, by the first device, to the second state responsive to transmitting the message.

Example 2 includes the subject matter of example 1, wherein the information comprises, for each connection, a source internet protocol (IP) address, a destination IP address, a source port, a destination port, and a protocol.

Example 3 includes the subject matter of any of examples 1 or 2, the first state comprises an online state and wherein the second state comprises an offline state.

Example 4 includes the subject matter of any of examples 1 to 3, switching to the second state comprises ceasing advertising availability of the first device to a router intermediary to the one or more clients and the first device.

Example 5 includes the subject matter of any of examples 1 to 4, wherein the signal comprises a command indicating the switch, the command comprising one of a first command type or a second command type.

Example 6 includes the subject matter of any of examples 1 to 5, wherein the first command type comprises an inbound node command specifying information relating to one or more inbound connections, and the second command type comprises an outbound command specifying information relating to one or more outbound connections.

Example 7 includes the subject matter of any of examples 1 to 6, the method further comprising, responsive to transmitting the message, receiving, by the first device, network traffic from the one or more second devices, the network traffic comprising data relating to one or more communication sessions associated with the plurality of connections of the one or more clients or the one or more servers maintained by the first device. The method includes communicating, by the first device, the network traffic between the one or more clients and the one or more servers, wherein switching from the first state to the second state is further responsive to completing the one or more communication sessions.

Example 8 includes the subject matter of any of examples 1 to 7, wherein the method includes receiving, by the first device, a second signal to switch from the second state back to the first state, the first device receiving the second signal responsive to an update of the first device. The method includes receiving, by the first device, one or more messages from each of the one or more second devices, the one or more messages comprising information relating to connections maintained by a respective second device. The method includes switching, by the first device, from the second state to the first state responsive to receiving the one or more messages.

Example 9 includes the subject matter of any of examples 1 to 8, wherein the method includes receiving, by the first device from a router intermediary to the one or more clients and the first device, responsive to switching back to the first state, data of a connection previously maintained by a second device of the one or more second devices.

Example 10 includes the subject matter of any of examples 1 to 9, wherein switching to the first state comprises advertising, by the first device, availability for connections with a router intermediary to the one or more clients and the first device.

Example 11 includes a method. The method includes receiving, by a first device intermediary to one or more clients and one or more servers, a signal to switch from a first state to a second state. The method includes receiving, by the first device, one or more messages from one or more second devices in a route health injection (RHI) deployment with the first device, each message comprising information relating to a plurality of connections of the one or more clients or the one or more servers maintained by a respective second device. The method includes switching, by the first device, to the second state responsive to transmitting the message.

Example 12 includes the subject matter of example 11, the first state comprises an offline state and wherein the second state comprises an online state.

Example 13 includes the subject matter of any of examples 11 or 12, the first device receives the signal responsive to at least one of an initial deployment of the first device or an update to the first device.

Example 14 includes the subject matter of any of examples 11 to 13, wherein the method includes receiving, by the first device from a router intermediary to the one or more clients and the first device, responsive to switching to the second state, data of a connection previously maintained by a second device of the one or more second devices.

Example 15 includes the subject matter of any of examples 11 to 14, wherein the method includes advertising, by the first device, availability for connections with the router, wherein the data of the connection is received responsive to advertising the availability.

Example 16 includes the subject matter of any of examples 11 to 15, wherein the information comprises, for each connection, a source internet protocol (IP) address, a destination IP address, a source port, a destination port, and a protocol.

Example 17 includes a system. The system includes one or more processors of a first device intermediary to one or more clients and one or more servers. The processors are configured to receive a signal to switch from a first state to a second state. The processors are further configured to transmit a message to one or more second devices in a route health injection (RHI) deployment with the first device, the message comprising information relating to a plurality of connections of the one or more clients or the one or more servers maintained by the first device. The processors are further configured to switch to the second state responsive to transmitting the message.

Example 18 includes the subject matter of example 17, wherein the information comprises, for each connection, a source internet protocol (IP) address, a destination IP address, a source port, a destination port, and a protocol.

Example 19 includes the subject matter of examples 17 or 18 wherein the first state comprises an online state and wherein the second state comprises an offline state.

Example 20 includes the subject matter of any of examples 17 to 19, wherein the signal comprises a command indicating the switch, the command comprising one of a first command type or a second command type, wherein the first command type comprises an inbound node command specifying information relating to one or more inbound connections, and the second command type comprises an outbound command specifying information relating to one or more outbound connections.

Example 21 includes the subject matter of any of examples 17 to 20, wherein the processors are configured to receive, responsive to transmitting the message, network traffic from the one or more second devices, the network traffic comprising data relating to one or more communication sessions associated with the plurality of connections of the one or more clients or the one or more servers maintained by the first device. The processors are configured to communicate the network traffic between the one or more clients and the one or more servers, wherein switching from the first state to the second state is further responsive to termination of the one or more communication sessions.

Example 22 includes a method. The method includes establishing, by a router intermediary to one or more clients and a first device, one or more first connections between the router and the first device. The method includes determining, by the router, an absence of an advertisement from the first device, responsive to the first device switching from a first state to a second state responsive to communicating information relating to the one or more first connections maintained by the first device to one or more second devices in a route health injection (RHI) deployment with the first device. The method includes routing, by the router, network traffic associated with the one or more first connections of the first device to the one or more second devices.

Example 23 includes the subject matter of example 22, wherein the method includes receiving, by the router, an advertisement from the first device responsive to the first device switching from the second state to the first state. The method includes establishing, by the router, one or more second connections between the router and the first device based on the advertisement. The method includes routing, by the router, network traffic associated with the one or more second devices to the first device.

Example 24 includes the subject matter of any of examples 22 or 23, wherein the method includes routing the network traffic to the one or more second devices to minimize disruption of the network traffic when the first device switches to the second state.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus, or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents. References to “or” can be construed as inclusive so that any terms described using “or” can indicate any of a single, more than one, and all of the described terms. For example, a reference to “at least one of ‘A’ and ‘B’” can include only “A,” only “B,” as well as both “A” and “B.” Such references used in conjunction with “comprising” or other open terminology can include additional items.

It will be further understood that various changes in the details, materials, and arrangements of the parts that have been described and illustrated herein may be made by those skilled in the art without departing from the scope of the following claims.

What is claimed is:

1. A method comprising:
receiving, by a first device intermediary to one or more clients and one or more servers, a signal to switch from a first state to a second state;
transmitting, by the first device, a message to one or more second devices in a route health injection (RHI) deployment with the first device, the message comprising information relating to a plurality of connections of the one or more clients or the one or more servers maintained by the first device; and
switching, by the first device, to the second state responsive to transmitting the message.

2. The method of claim 1, wherein the information comprises, for each connection, a source internet protocol (IP) address, a destination IP address, a source port, a destination port, and a protocol.

3. The method of claim 1, wherein the first state comprises an online state and wherein the second state comprises an offline state.

4. The method of claim 1, wherein switching to the second state comprises ceasing advertising availability of the first device to a router intermediary to the one or more clients and the first device.

5. The method of claim 1, wherein the signal comprises a command indicating the switch, the command comprising one of a first command type or a second command type.

6. The method of claim 5, wherein the first command type comprises an inbound node command specifying information relating to one or more inbound connections, and the second command type comprises an outbound command specifying information relating to one or more outbound connections.

7. The method of claim 1, further comprising:
responsive to transmitting the message, receiving, by the first device, network traffic from the one or more second devices, the network traffic comprising data relating to one or more communication sessions associated with the plurality of connections of the one or more clients or the one or more servers maintained by the first device; and
communicating, by the first device, the network traffic between the one or more clients and the one or more servers, wherein switching from the first state to the second state is further responsive to termination of the one or more communication sessions.

8. The method of claim 1, further comprising:
receiving, by the first device, a second signal to switch from the second state back to the first state, the first device receiving the second signal responsive to an update of the first device;
receiving, by the first device, one or more messages from each of the one or more second devices, the one or more messages comprising information relating to connections maintained by a respective second device; and
switching, by the first device, from the second state to the first state responsive to receiving the one or more messages.

9. The method of claim 8, further comprising:
receiving, by the first device from a router intermediary to the one or more clients and the first device, responsive to switching back to the first state, data of a connection previously maintained by a second device of the one or more second devices.

10. The method of claim 8, wherein switching to the first state comprises advertising, by the first device, availability for connections with a router intermediary to the one or more clients and the first device.

11. A method comprising:
receiving, by a first device intermediary to one or more clients and one or more servers, a signal to switch from a first state to a second state;
receiving, by the first device, one or more messages from one or more second devices in a route health injection (RHI) deployment with the first device, each message comprising information relating to a plurality of connections of the one or more clients or the one or more servers maintained by a respective second device; and
switching, by the first device, to the second state responsive to transmitting the message.

12. The method of claim 11, wherein the first state comprises an offline state and wherein the second state comprises an online state.

13. The method of claim 11, wherein the first device receives the signal responsive to at least one of an initial deployment of the first device or an update to the first device.

14. The method of claim 11, further comprising receiving, by the first device from a router intermediary to the one or more clients and the first device, responsive to switching to the second state, data of a connection previously maintained by a second device of the one or more second devices.

15. The method of claim 14, further comprising advertising, by the first device, availability for connections with the router, wherein the data of the connection is received responsive to advertising the availability.

16. The method of claim 11, wherein the information comprises, for each connection, a source internet protocol (IP) address, a destination IP address, a source port, a destination port, and a protocol.

17. A system, comprising:
one or more processors of a first device intermediary to one or more clients and one or more servers, the one or more processors configured to:
receive a signal to switch from a first state to a second state;
transmit a message to one or more second devices in a route health injection (RHI) deployment with the first device, the message comprising information relating to a plurality of connections of the one or more clients or the one or more servers maintained by the first device; and
switch to the second state responsive to transmitting the message.

18. The system of claim 17, wherein the information comprises, for each connection, a source internet protocol (IP) address, a destination IP address, a source port, a destination port, and a protocol.

19. The system of claim 17, wherein the first state comprises an online state and wherein the second state comprises an offline state.

20. The system of claim 17, wherein the signal comprises a command indicating the switch, the command comprising one of a first command type or a second command type, wherein the first command type comprises an inbound node command specifying information relating to one or more inbound connections, and the second command type comprises an outbound command specifying information relating to one or more outbound connections.

21. The system of claim 17, wherein the one or more processors are configured to:
receive, responsive to transmitting the message, network traffic from the one or more second devices, the network traffic comprising data relating to one or more communication sessions associated with the plurality of connections of the one or more clients or the one or more servers maintained by the first device; and
communicate the network traffic between the one or more clients and the one or more servers, wherein switching from the first state to the second state is further responsive to termination of the one or more communication sessions.

22. A method comprising:
establishing, by a router intermediary to one or more clients and a first device, one or more first connections between the router and the first device;
determining, by the router, an absence of an advertisement from the first device, responsive to the first device switching from a first state to a second state responsive to communicating information relating to the one or more first connections maintained by the first device to one or more second devices in a route health injection (RHI) deployment with the first device; and
routing, by the router, network traffic associated with the one or more first connections of the first device to the one or more second devices.

23. The method of claim 22, further comprising:
receiving, by the router, an advertisement from the first device responsive to the first device switching from the second state to the first state;
establishing, by the router, one or more second connections between the router and the first device based on the advertisement; and
routing, by the router, network traffic associated with the one or more second devices to the first device.

24. The method of claim 22, further comprising routing the network traffic to the one or more second devices to minimize disruption of the network traffic when the first device switches to the second state.
